(19) United States
(12) Patent Application Publication
(10) Pub. No.: US 2025/0210969 A1
(43) Pub. Date: Jun. 26, 2025

(54) PRE-CHARGE CIRCUITS FOR DIRECT CURRENT BUS TRANSIENT VOLTAGE PROTECTION

(71) Applicant: ABB Schweiz AG, Baden (CH)

(72) Inventors: Jing Xu, Cary, NC (US); Arun Kumar Kadavelugu, McKinney, TX (US); Yuxiang Shi, Cary, NC (US); Eddy C. Aeloiza, Apex, NC (US); Xiaoqing Song, Fayetteville, AR (US)

(21) Appl. No.: 19/080,204

(22) Filed: Mar. 14, 2025

Related U.S. Application Data
(63) Continuation of application No. PCT/US2022/044014, filed on Sep. 19, 2022.

(51) Int. Cl. H02H 7/12; H02H 9/00; H02H 9/04

(52) U.S. Cl. CPC H02H 7/1213; H02H 9/005; H02H 9/042

(57) ABSTRACT

Pre-charge circuits for a direct current (DC) bus are provided. In one aspect, the pre-charge circuit comprises a varistor, a bypass circuit, a solid-state switch, and a voltage divider circuit. The bypass circuit is configured to receive a current in response to the DC bus charging. The solid-state switch is in series with the varistor, with a common node electrically coupled therebetween. The solid-state switch is configured to selectively couple the varistor with the DC bus in response to the bypass circuit receiving the current. The voltage divider circuit is configured to divide a voltage of the DC bus between the varistor and the solid-state switch.

### BACKGROUND

The field of the disclosure relates to transient voltage protection, and more particularly, to transient voltage protection for direct current (DC) busses.

DC systems provide benefits to customers for systems such as marine distribution systems, battery energy storage systems, microgrids, and datacenters. DC power distribution systems are characterized by a variety of configurations, including the use of voltage source converters and capacitor storage or other storage systems coupled to the DC distribution bus. Metal-oxide varistors (MOVs) are often used to provide transient voltage protection for voltage rails by clamping the voltage on the rails when a transient voltage on the rails exceeds the peak clamping voltage of the MOV. When choosing a MOV for a particular implementation, there are three main requirements. First, the peak clamping voltage of the MOV should be the maximum allowable transient voltage on the rail. Second, the breakdown voltage of the MOV should be less than the operating voltage of the rail under a wide variety of operating conditions, such that the MOV does not begin to conduct when the rail voltage is within its design parameters. Third, the leakage current of the MOV should be low enough during the steady state voltages on the rail to ensure that the resulting power loss is within the power dissipation capability of the MOV. These conflicting requirements mandate a small operating region for the MOV when the rail voltage is close to the maximum allowable transient voltage on the rail.

FIG. 1 illustrates a known electrical characteristic graph 100 for MOVs. In FIG. 1, a MOV operating region 102 is bounded by the maximum allowable transient voltage 104 on the rail and the steady state voltage 106 of the rail. Further, it may be difficult to select a MOV that meets the requirements for transient voltage protection, while exhibiting a low leakage current during steady state operation to minimize the heating of the MOV.

Based on the forgoing discussion, it therefore remains desirable to improve upon voltage clamping circuits for DC busses.

### BRIEF DESCRIPTION

In one aspect, a pre-charge circuit for a DC bus is provided. The pre-charge circuit comprises a varistor, a bypass circuit, a solid-state switch, and a voltage divider circuit. The bypass circuit is configured to receive a current in response to the DC bus charging. The solid-state switch is in series with the varistor, with a common node electrically coupled therebetween. The solid-state switch is configured to selectively couple the varistor with the DC bus in response to the bypass circuit receiving the current. The voltage divider circuit is configured to divide a voltage of the DC bus between the varistor and the solid-state switch.

In another aspect, a power distribution system is provided. The power distribution system comprises a voltage converter and a pre-charge circuit. The voltage converter is configured to selectively couple to a voltage source, and in response thereto, to charge a DC bus of the voltage converter to a target voltage. The pre-charge circuit is coupled in parallel with the DC bus, and comprises a varistor, a bypass circuit, a solid-state switch, and a voltage divider. The bypass circuit is configured to receive a current in response to charging the DC bus. The solid-state switch is in series with the varistor, with a common node electrically coupled therebetween. The solid-state switch is configured to selectively couple the varistor with the DC bus in response to the bypass circuit receiving the current, and to clamp transient voltages on the DC bus that exceed the target voltage by a threshold voltage. The voltage divider circuit is coupled to the DC bus and the common node, where the voltage divider circuit is configured to divide the target voltage of the DC bus between the varistor and the sold-state switch.

In another aspect, a pre-charge circuit for a DC bus of a voltage converter is provided. The pre-charge circuit comprises a first resistor and a second resistor, at least one varistor, at least one solid-state switch, and a capacitor and a third resistor. The first resistor and the second resistor are in series between a first terminal and a second terminal of the DC bus, with a common node electrically coupled between the first resistor and the second resistor. A voltage between the first terminal and the second terminal comprises a DC bus voltage. The at least one varistor is coupled in parallel between the first terminal and the common node. The at least one solid-state switch is coupled in series between the common node and the second terminal. The capacitor and third resistor are coupled in series between the first terminal and the at least one solid-state switch, where the capacitor and the third resistor are configured to receive a current from the DC bus in response to the voltage converter charging the DC bus, and where the current terminates in response to the DC bus being charged to the DC bus voltage. The first resistor and the second resistor are configured to divide the DC bus voltage between the at least one varistor and the at least one solid-state switch. The at least one solid-state switch is configured to couple the common node to the second terminal of the DC bus in response to the capacitor and the third resistor receiving the current, and uncouple the common node from the second terminal of the DC bus in response to at least one of the current terminating and a current through the at least one solid-state switch falling below a threshold current.

### DRAWINGS

These and other features, aspects, and advantages of the present disclosure will become better understood when the following detailed description is read with reference to the accompanying drawings in which like characters represent like parts throughout the drawings, wherein:

FIG. 1 depicts a known electrical characteristics graph for MOVs.

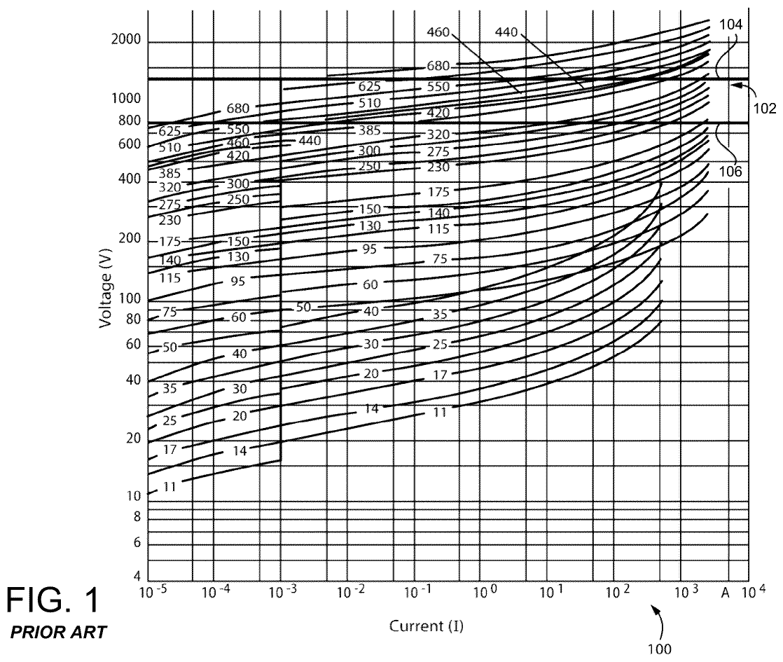

FIG. 2 depicts a block diagram of a pre-charge circuit for a DC bus in an exemplary embodiment.

FIG. 3 depicts current flowing through the pre-charge circuit of FIG. 2 in an exemplary embodiment.

FIG. 4 depicts a circuit diagram of a transient voltage suppression (TVS) thyristor-based pre-charge circuit of FIG. 2 in an exemplary embodiment.

FIG. 5 depicts a known graph illustrating electrical characteristics of a TVS thyristor.

FIG. 6 depicts a graph illustrating the operation of the pre-charge circuit of FIG. 4 during a pre-charge of a DC bus in an exemplary embodiment.

FIG. 7 depicts a circuit diagram of an insulated-gate bipolar transistor (IGBT)-based pre-charge circuit of FIG. 2 in an exemplary embodiment.

FIG. 8 depicts a circuit diagram of another IGBT-based pre-charge circuit of FIG. 2 in an exemplary embodiment.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As discussed previously, protecting DC busses using a MOV-only solution can be difficult or impossible, given a large gap between a MOV's steady state voltage rating and the clamping voltage rating of the MOV during steady state operation.

When an alternating current (AC)/DC front-end voltage converter is powered up by coupling the voltage converter to an AC source, the instantaneous application of the source to the voltage converter may result in a high voltage spike across the DC bus. The high voltage spike is detrimental to the semiconductors of the voltage converter and the DC bus capacitors. Using just an MOV as the voltage clamp on the DC bus is not an ideal solution due to the large gap between the steady state voltage rating of the MOV and the transient voltage blocking capability of the MOV. Choosing a lower transient voltage rated MOV (for reliable protection) will have a correspondingly lower steady state voltage blocking rating. This may result in the failure of the MOV during steady state operation, when the MOV is exposed to the DC bus voltage.

In one of the embodiments described herein, a pre-charge circuit comprises a varistor, a bypass circuit, a solid-state switch, and a voltage divider circuit. The pre-charge circuit is coupled across a DC bus of a voltage converter. When the DC bus is initially charged by the voltage converter (e.g., when the voltage converter is powered up by coupling the voltage converter to an AC source), the bypass circuit receives a current, which turns on the solid-state switch (i.e., the solid-state switch conducts), and couples the varistor across the DC bus. In embodiments where the solid-state switch comprises a transient voltage suppression TVS thyristor, the bypass circuit provides most of the DC bus voltage across the TVS thyristor to turn it on at a desired DC bus voltage, and also provides the turn on current to the TVS thyristor.

If a voltage transient is generated on the DC bus, then the varistor clamps the voltage transient, thereby protecting the voltage converter, the DC bus capacitors, and any devices coupled to the DC bus, from damage. After the DC bus is charged, the solid-state switch turns off (i.e., the solid-state switch no longer conducts), which decouples the varistor from the DC bus. The voltage divider circuit divides the DC bus voltage between the varistor and the solid-state switch, such that the varistor is not subjected to the full DC voltage of the DC bus. The reduced voltage on the varistor lowers the leakage current through the varistor after the DC bus is charged and consequentially, lowers the power dissipated by the varistor after the DC bus is charged.

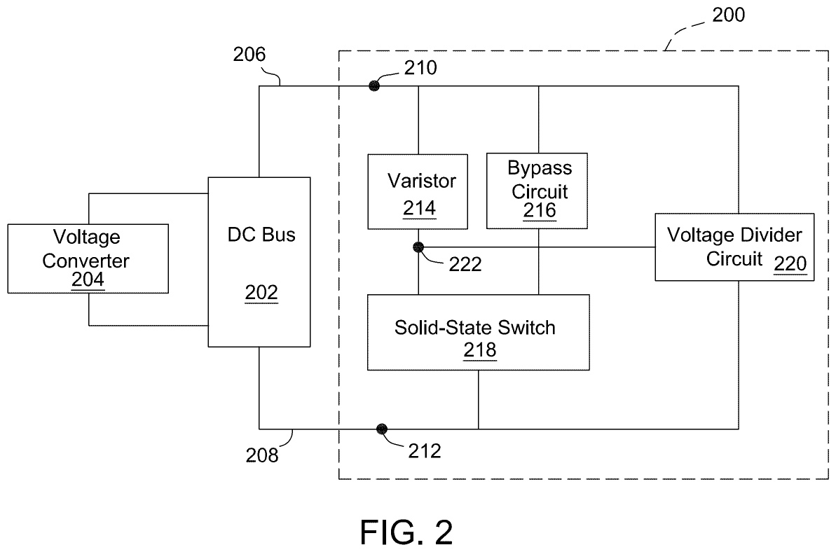

FIG. 2 depicts a block diagram of a pre-charge circuit 200 for a DC bus 202 in an exemplary embodiment. In this embodiment, DC bus 202 is powered by a voltage converter 204 (e.g., an AC/DC front-end converter). Voltage converter 204 is selectively powered by a voltage source (not shown). In this embodiment, pre-charge circuit 200 operates to clamp voltage transients on DC bus 202 when DC bus 202 is charged by voltage converter 204 (e.g., when voltage converter 204 is selectively coupled to a source, which may generate undesirable voltage transients or voltage spikes on DC bus 202).

Pre-charge circuit 200 comprises any component, system, or device which performs the functions described herein for pre-charge circuit 200. Pre-charge circuit 200 will be described with respect to various discrete elements, which perform functions. These elements may be combined in different embodiments or segmented into different discrete elements in other embodiments.

In this embodiment, pre-charge circuit 200 is coupled across DC bus 202 via terminals 206, 208 of DC bus 202. Terminals 206, 208 represent the different voltages at DC bus 202 with respect to a reference. For example, the voltage across terminals 206, 208 of DC bus 202 may be about one thousand volts when DC bus 202 is charged to a target voltage (e.g., the target voltage of DC bus 202 during steady-state operation).

In this embodiment, nodes 210, 212 of pre-charge circuit 200 are coupled across DC bus 202 via terminals 206, 208, respectively. In particular, node 210 of pre-charge circuit 200 is coupled to terminal 206 of DC bus 202 and node 212 of pre-charge circuit 200 is coupled to terminal 208 of DC bus 202.

In this embodiment, pre-charge circuit 200 comprises a varistor 214, a bypass circuit 216, a solid-state switch 218, and a voltage divider 220. Varistor 214 comprises any component, system, or device that exhibits a nonlinear, non-ohmic current-voltage characteristic. In some embodiments, varistor 214 comprises a MOV. In other embodiments, varistor 214 comprises multiple varistors in parallel. In these embodiments, each of the multiple varistors in parallel share a portion of the current provided by DC bus 202 when varistor(s) 214 operate to clamp the transient voltages on DC bus 202.

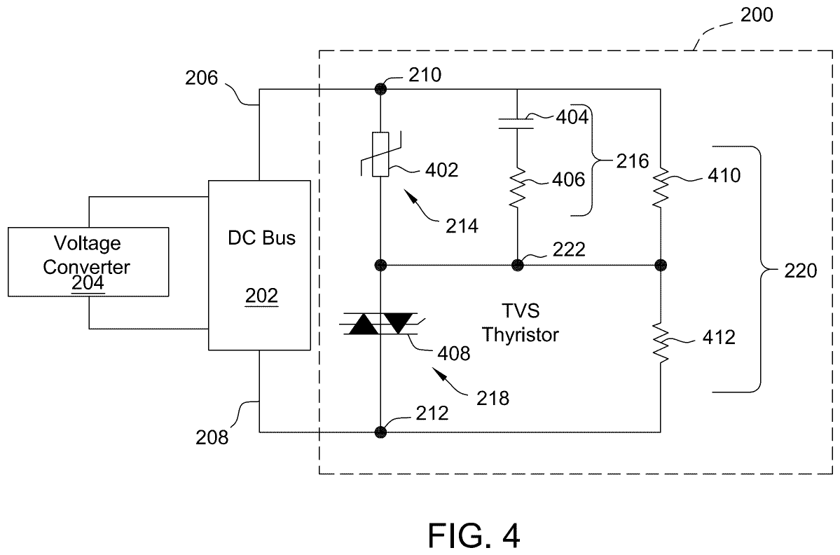

Bypass circuit 216 comprises any component, system, or device that provides a trigger to solid-state switch 218 in response to DC bus 202 charging. In some embodiments, the trigger comprises a current. The trigger (e.g., a current) terminates when DC bus 202 is charged to a target voltage (e.g., the steady state voltage of DC bus 202). In some embodiments, bypass circuit 216 comprises a capacitor and/or a resistor in series with a capacitor, which provides a bypass current to solid-state switch 218 from DC bus 202 as DC bus 202 charges to the target voltage. In some embodiments, bypass circuit 216 is in parallel with varistor 214 (e.g., both varistor 214 and bypass circuit 216 are coupled between nodes 210 and common node 222 of pre-charge circuit 200. This configuration will be discussed in more detail with respect to FIG. 4.

Solid-state switch 218 is in series with varistor 214, with a common node 222 electrically coupled between varistor 214 and solid-state switch 218. Solid-state switch 218 comprises any component, system, or device that selectively couples varistor 214 across terminals 206, 208 of DC bus 202 when bypass circuit 216 provides the trigger to solid-state switch 218. In some embodiments, solid-state switch 218 comprises a TVS thyristor, a TVS diode, an IGCT, other types of solid-state switches, and combinations thereof. In response to bypass circuit 216 providing the trigger to solid-state switch 218, solid-state switch 218 conducts and couples varistor 214 across terminals 206, 208 of DC bus 202 to clamp voltage transients on DC bus 202. Once DC bus 202 is charged and current no longer flows through solid-state switch 218 and/or bypass circuit 216, solid-state switch 218 turns off and uncouples varistor 214 from terminals 206, 208 of DC bus 202.

In some embodiments, solid-state switch 218 comprises multiple solid-state switches in series between node 212 and common node 222, which reduces the voltage stress on each switch in series as compared to a single solid-state switch between node 212 and common node 222. In other embodiments, solid-state switch 218 comprises multiple solid-state switches in parallel, with each switch in parallel sharing a portion of the current from DC bus 202 as varistor 214 clamps transient voltages across terminals 206, 208 of DC bus 202. In other embodiments, solid-state switch 218 comprises a combination of parallel and series solid-state switches, which provides both a reduced voltage stress and also current sharing between the solid-state switches.

In this embodiment, voltage divider circuit 220 is coupled with terminals 206, 208 of DC bus 202 and also with common node 222. Voltage divider circuit 220 comprises any component, system, or device that divides or distributes the voltage across DC bus 202 between varistor 214 and solid-state switch 218. Dividing the voltage across DC bus 202 between varistor 214 and solid-state switch 218 reduces the voltage across varistor 214, thereby reducing the leakage current through varistor 214 when solid-state switch 218 is off. In some embodiments, voltage divider circuit 220 applies a voltage across varistor 214 based on a target leakage current for varistor 214 when DC bus 202 is charged to a target voltage. In these embodiments, the target leakage current for varistor 214 may be about one hundred microamps, which ensures that the power dissipated by varistor 214 after DC bus 202 is charged is minimized. In some embodiments, voltage divider circuit 220 comprises resistors in series between node 210 and node 212, with common node 222 electrically coupled between the resistors, which divides, shares, distributes, or segments the voltage across DC bus 202 between varistor 214 and solid-state switch 218.

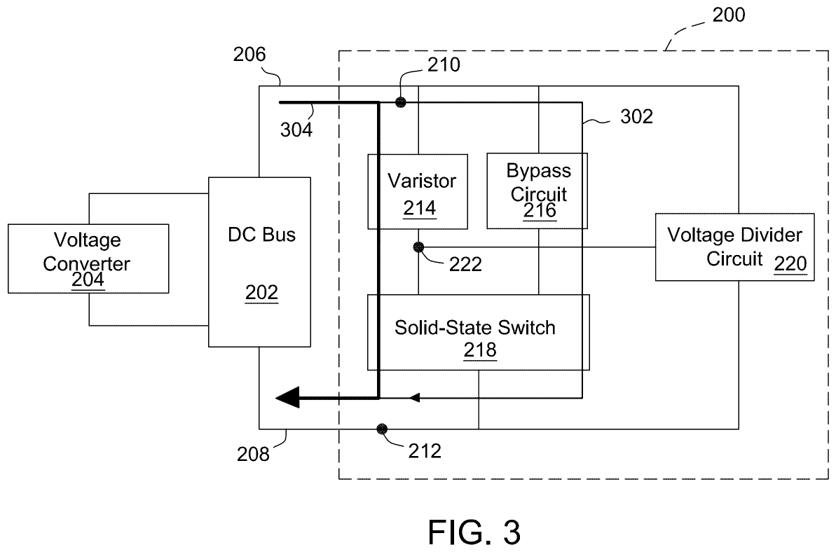

FIG. 3 depicts current flowing through pre-charge circuit 200 of FIG. 2 in an exemplary embodiment. Initially, the voltage across DC bus 202 may be about zero. Initially, solid-state switch 218 is off. When voltage converter 204 is coupled to a voltage source (not shown), voltage converter 204 begins charging DC bus 202. Charging DC bus 202 provides a bypass current 302 through bypass circuit 216. Bypass current 302 triggers solid-state switch 218 into conduction, which couples varistor 214 across terminals 206, 208 of DC bus 202. During a voltage transient on DC bus 202, when the voltage on DC bus 202 exceeds the breakdown voltage of varistor 214, varistor 214 conducts a clamp current 304 provided by DC bus 202, which is dissipated by varistor 214 as heat. During conduction of clamp current 304 by varistor 214, the voltage across terminals 206, 208 of DC bus 202 is clamped to about the peak clamping voltage of varistor 214, which protects voltage converter 204 and other devices coupled to DC bus 202 from damage. Once DC bus 202 is charged and settled to a steady state value, solid-state switch 218 no longer conducts, which decouples varistor 214 from terminals 206, 208 of DC bus 202. With DC bus 202 charged (e.g., to a target voltage), and solid-state switch 218 and varistor 214 off, bypass current 302 and clamp current 304 terminate. During steady state operation, when DC bus 202 is charged to the target voltage, voltage divider circuit 220 divides the voltage across terminals 206, 208 of DC bus 202 such that neither varistor 214 nor solid-state switch 218 are subjected to the full DC bus voltage across terminals 206, 208 of DC bus 202.

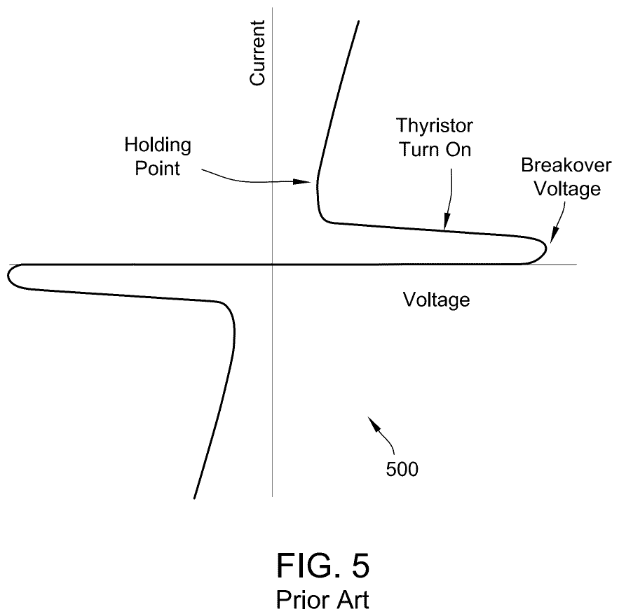

FIG. 4 depicts a circuit diagram of a transient voltage suppression (TVS) thyristor-based pre-charge circuit 200 of FIG. 2 in an exemplary embodiment, and FIG. 5 depicts a known graph 500 illustrating electrical characteristics of a TVS thyristor.

In the embodiment depicted in FIG. 4, varistor 214 comprises a MOV 402, bypass circuit 216 comprises a capacitor 404 in series with a resistor 406, solid-state switch 218 comprises a TVS thyristor 408, and voltage divider circuit 220 comprises resistors 410, 412 coupled in series across nodes 210, 212 with common node 222 coupled between resistors 410, 412. In this embodiment, bypass circuit 216 is in parallel with MOV 402. With reference to FIG. 5, TVS thyristor 408 is a two-terminal bi-directional device. TVS thyristor 408 remains turned off while the voltage across TVS thyristor 408 is less than the breakover voltage of TVS thyristor 408. TVS thyristor 408 turns on when the voltage across TVS thyristor 408 increases to the breakover voltage for TVS thyristor 408. TVS thyristor 408 remains turned on as long as its conduction current is greater than holding point current for TVS thyristor 408, and then TVS thyristor 408 turns off when the conduction current decreases below the holding point current.

Referring again to FIG. 4, with TVS thyristor 408 off, TVS thyristor 408 blocks a portion of the voltage across DC bus 202 and MOV 402 blocks a portion of the voltage across DC bus 202, depending on the values for resistors 410, 412. When DC bus 202 is charged, current flowing through capacitor 404 and resistor 406 will charge a parasitic capacitor in TVS thyristor 408, which increases the voltage across TVS thyristor 408. Resistor 406 operates to limit the inrush current when TVS thyristor 408 turns on. When the voltage of TVS thyristor 408 reaches the breakover voltage for TVS thyristor 408, TVS thyristor 408 turns on, and couples MOV 402 across terminals 206, 208 of DC bus 202. The voltage across TVS thyristor 408 may be a few volts when TVS thyristor 408 is on, and therefore, the clamping voltage across DC bus 202 is substantially the peak clamping voltage of MOV 402. During a voltage transient across DC bus 202, MOV 402 and TVS thyristor 408 in series conduct a shared current to clamp the voltage across DC bus 202. When the current through TVS thyristor 408 reduces below the holding current for TVS thyristor 408, TVS thyristor 408 turns off, which decouples MOV 402 from DC bus 202. Resistors 410, 412 of voltage divider circuit 220 are selected to reduce the voltage across MOV 402 to less than the DC voltage across DC bus 202, which reduces the leakage current through MOV 402.

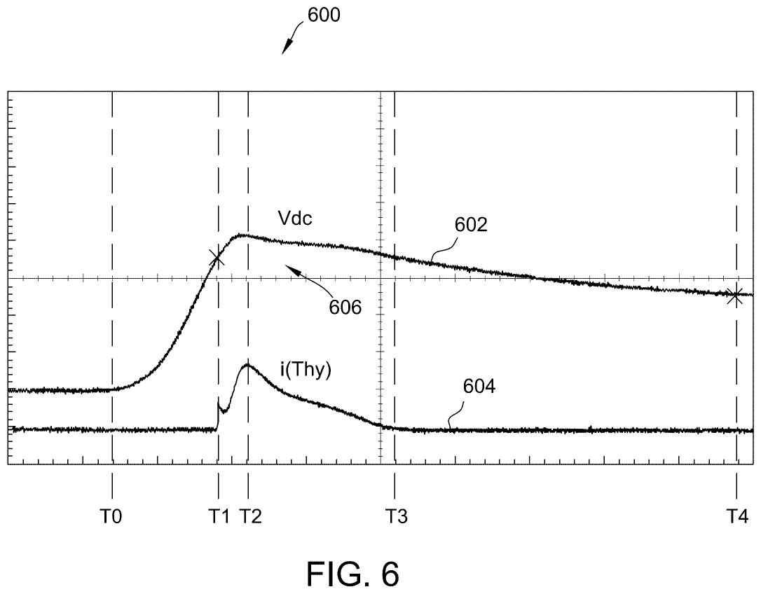

FIG. 6 depicts a graph 600 illustrating the operation of the pre-charge circuit of FIG. 4 during a pre-charge of DC bus 202 in an exemplary embodiment. Graph 600 depicts both a DC bus voltage 602 of DC bus 202 and a thyristor current 604 of TVS thyristor 408 from time T0 to time T4. At time T0, Voltage converter 204 begins charging DC bus 202 (see FIG. 4). DC bus voltage 602 increases from T0 to T1, which charges the parasitic capacitor of TVS thyristor 408 via capacitor 404 and resistor 406 of bypass circuit 216, turning TVS thyristor 408 on and coupling MOV 402 across DC bus 202. DC bus voltage 602 continues to increase, and because the voltage across TVS thyristor 408 is low when TVS thyristor 408 is on, the voltage across MOV 402 is substantially DC bus voltage 602. A voltage transient 606 is present in DC bus voltage 602. DC bus voltage 602 continues to increase until MOV 402 begins to conduct at time T1. DC bus voltage 602 continues to increase until the peak clamping voltage of MOV 402 is reached at time T2, thereby clamping DC bus voltage 602 at about the peak clamping voltage of MOV 402. Thyristor current 604 decreases from time T2 to time T3 as the voltage across MOV 402 decreases, where thyristor current 604 falls below the holding current for TVS thyristor 408, and TVS thyristor 408 turns off. DC bus voltage 602 continues to decrease from time T3 to time T4 as voltage transient 606 subsides, where the DC bus voltage 602 reaches its steady state target voltage at T4.

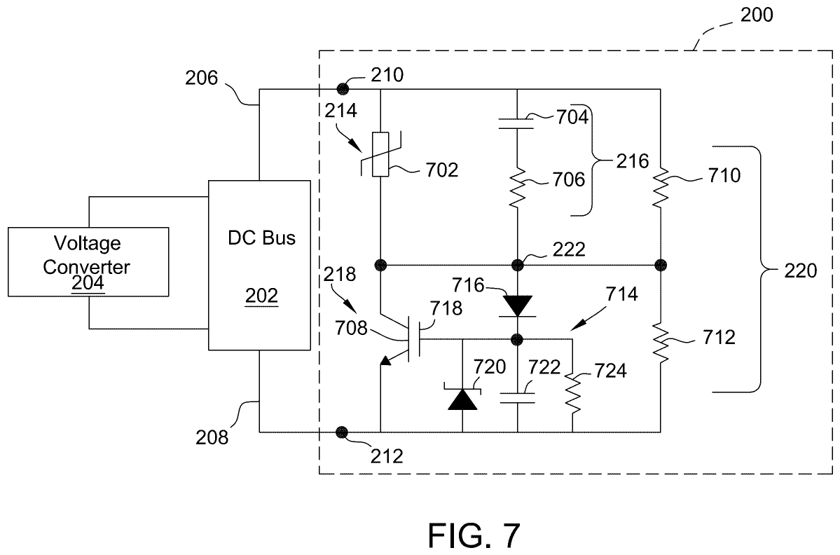

FIG. 7 depicts a circuit diagram of an IGBT-based pre-charge circuit 200 of FIG. 2 in an exemplary embodiment. In the embodiment depicted in FIG. 7, varistor 214 comprises a MOV 702, bypass circuit 216 comprises a capacitor 704 in series with a resistor 706, solid-state switch 218 comprises an IGBT 708, and voltage divider circuit 220 comprises resistors 710, 712 coupled in series across nodes 210, 212. Electrically coupled between resistors 710, 712 is common node 222. In this embodiment, bypass circuit 216 is in parallel with MOV 702. IGBT 708 is operated by a control circuit 714 comprising a diode 716 having an anode coupled to common node 222 and a cathode coupled to a gate 718 of IGBT 708, a Zener diode 720 having a cathode coupled to gate 718 and an anode coupled to node 212, a capacitor 722 coupled between gate 718 and node 212, and a resistor coupled between gate 718 and node 212, which places Zener diode 720, capacitor 722, and resistor 724 in parallel with each other.

As DC bus 202 charges, current flows through capacitor 704 and resistor 706 of bypass circuit 216, which then flows into diode 716 of control circuit 714. The current charges capacitor 722 of control circuit 714, which increases the voltage of gate 718 of IGBT 708 with respect to node 212. Once the voltage between gate 718 and node 212 reaches the threshold voltage for IGBT 708, IGBT 708 turns on and couples MOV 702 across DC bus 202. During a voltage transient on DC bus 202, MOV 702 and IGBT 708 conduct current and clamp the voltage across DC bus 202 at about the peak clamping voltage of MOV 702. Zener diode 720 of control circuit 714 operates to clamp the voltage at gate 718 below the maximum allowable voltage between gate 718 and node 212. As the voltage transient on DC bus 202 subsides, the current through bypass circuit 216 decreases, and resistor 724 operates to discharge capacitor 722 and reduce the voltage between gate 718 and node 212 below the threshold voltage of IGBT 708, which turns off IGBT 708. When IGBT 708 turns off, MOV 702 is decoupled from DC bus 202. Resistors 710, 712 of voltage divider circuit 220 are selected to reduce the voltage across MOV 702 to less than the DC voltage across DC bus 202, which reduces the leakage current through MOV 702.

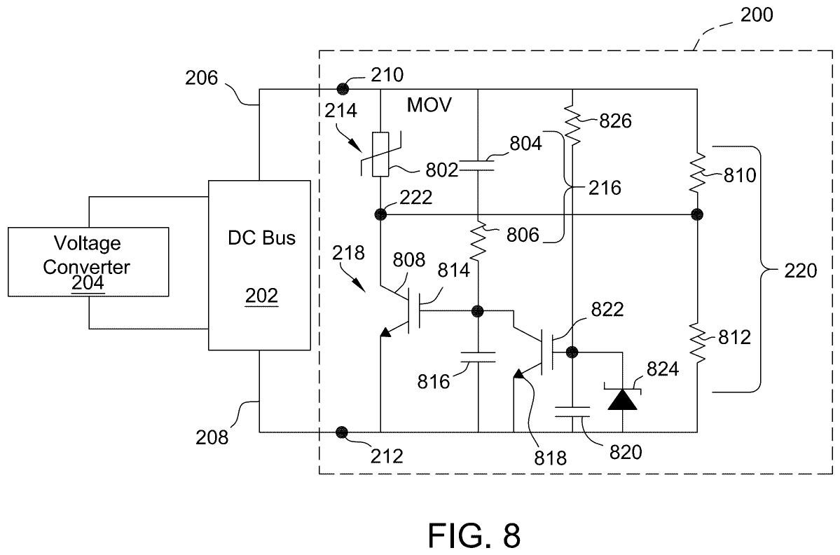

FIG. 8 depicts a circuit diagram of another IGBT-based pre-charge circuit 200 of FIG. 2 in an exemplary embodiment. In the embodiment depicted in FIG. 8, varistor 214 comprises a MOV 802, bypass circuit 216 comprises a capacitor 804 in series with a resistor 806, solid-state switch 218 comprises an IGBT 808, and voltage divider circuit 220 comprises resistors 810, 812 coupled in series across nodes 210, 212. Electrically coupled between resistors 810, 812 is common node 222. In this embodiment, bypass circuit 216 is not in parallel with MOV 802. Rather, bypass circuit 216 is coupled between node 210 and a gate 814 of IGBT 808. A capacitor 816 is coupled between gate 814 and node 212. An IGBT 818 is coupled in parallel with capacitor 816. A capacitor 820 is coupled between a gate 822 of IGBT 818 and node 212, and a Zener diode 824 has a cathode coupled to gate 822 and an anode coupled to node 212. A resistor 826 is coupled between node 210 and gate 822 of IGBT 818.

As DC bus 202 charges, current flows through capacitor 804 and resistor 806 of bypass circuit 216, which charges capacitor 816 coupled to gate 814 of IGBT 808. Once the voltage between gate 814 and node 212 reaches the threshold voltage for IGBT 808, IGBT 808 turns on and couples MOV 802 across DC bus 202. During a voltage transient on DC bus 202, MOV 802 and IGBT 808 conduct current and clamp the voltage across DC bus 202 at about the peak clamping voltage of MOV 802. As DC bus 202 charges, current also flows through resistor 826 and charges capacitor 820. Charging capacitor 820 increases the voltage between gate 822 of IGBT 818 and node 212, which turns on IGBT 818 when the voltage between gate 822 and node 212 reaches the threshold voltage of IGBT 818. IGBT 818 turns on and decreases the voltage between gate 814 of IGBT 808 and node 212 below the threshold voltage of IGBT 808, which turns off IGBT 808. When IGBT 808 turns off, MOV 802 is decoupled from DC bus 202. Zener diode 824 operates to clamp the voltage between gate 822 of IGBT 818 and node 212 below the maximum allowable voltage for IGBT 818. The capacitance values of capacitor 804, 816, 820 and the resistance values of resistors 806, 826 are selected such that IGBT 808 is turned on during charging of DC bus 202 and IGBT 808 is turned off when a transient voltage across DC bus 202 has been clamped by MOV 802 and has subsided.

An example technical effect of the embodiments described herein includes at least one of: (a) improving the reliability of voltage clamp circuits by distributing the DC bus voltage between a varistor and a solid-state switch; (b) reducing the leakage current through the varistor during steady state operation; (c) providing voltage transient protection on DC busses using low-cost components; and (d) providing voltage transient protection on DC busses without active control schemes or dedicated gate driver circuits.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A pre-charge circuit for a direct current (DC) bus, the pre-charge circuit comprising:
a varistor;
a bypass circuit configured to receive a current in response to the DC bus charging;
a solid-state switch in series with the varistor, with a common node electrically coupled therebetween, wherein the solid-state switch is configured to selectively couple the varistor with the DC bus in response to the bypass circuit receiving the current; and
a voltage divider circuit coupled with the DC bus and to the common node, wherein the voltage divider circuit is configured to divide a voltage of the DC bus between the varistor and the solid-state switch.

2. The pre-charge circuit of claim 1, wherein:
the voltage divider circuit is further configured to divide the voltage of the DC bus between the varistor and the solid-state switch based on a target leakage current for the varistor when the DC bus is charged.

3. The pre-charge circuit of claim 2, wherein:
the target leakage current for the varistor is less than about one hundred microamps.

4. The pre-charge circuit of claim 1, wherein the voltage divider circuit comprises:
a first resistor in parallel with the varistor and the bypass circuit; and
a second resistor in series with the first resistor and in parallel with the solid-state switch.

5. The pre-charge circuit of claim 1, wherein:
the current terminates in response to the DC bus being charged, and
the solid-state switch is further configured to uncouple the varistor from the DC bus in response to at least one of the current terminating and a current through the solid-state switch falling below a threshold current.

6. The pre-charge circuit of claim 1, wherein the bypass circuit comprises:
a capacitor; and
a resistor in series with the capacitor.

7. The pre-charge circuit of claim 6, wherein the solid-state switch comprises an integrated gate-commutated thyristor (IGCT).

8. The pre-charge circuit of claim 6, wherein a series combination of the capacitor and the resistor is in parallel with the varistor.

9. The pre-charge circuit of claim 8, wherein the solid-state switch comprises at least one of a transient voltage suppression (TVS) thyristor, a TVS diode, and an integrated gate-commutated thyristor (IGCT).

10. The pre-charge circuit of claim 1, wherein the solid-state switch comprises a plurality of solid-state switches coupled in series with each other.

11. The pre-charge circuit of claim 1, wherein the varistor comprises a plurality of varistors coupled in parallel with each other.

12. The pre-charge circuit of claim 1, wherein the varistor is configured to clamp at least one transient voltage on the DC bus generated in response to the DC bus charging.

13. A power distribution system, comprising:
a voltage converter configured to selectively couple to a voltage source, and in response thereto, to charge a direct current (DC) bus of the voltage converter to a target voltage; and
a pre-charge circuit coupled in parallel with the DC bus, the pre-charge circuit comprising:
a varistor;
a bypass circuit configured to receive a current in response to charging the DC bus;
a solid-state switch in series with the varistor, with a common node electrically coupled therebetween, wherein the solid-state switch is configured to selectively couple the varistor with the DC bus in response to the bypass circuit receiving the current, and to clamp transient voltages on the DC bus that exceed the target voltage by a threshold voltage; and
a voltage divider circuit coupled with the DC bus and to the common node, wherein the voltage divider circuit is configured to divide the target voltage of the DC bus between the varistor and the solid-state switch.

14. The power distribution system of claim 13, wherein:
the voltage divider circuit is further configured to divide the target voltage of the DC bus between the varistor and the solid-state switch based on a target leakage current for the varistor when the DC bus is at the target voltage.

15. The power distribution system of claim 13, wherein:
the current terminates in response to the DC bus being charged to the target voltage, and
the solid-state switch is further configured to uncouple the varistor from the DC bus in response to at least one of the current terminating and a current through the solid-state switch falling below a threshold current.

16. The power distribution system of claim 13, wherein the bypass circuit comprises:
a capacitor; and
a resistor in series with the capacitor.

17. The power distribution system of claim 16, wherein the solid-state switch comprises an integrated gate-commutated thyristor (IGCT).

18. The power distribution system of claim 16, wherein:
a series combination of the capacitor and the resistor is in parallel with the varistor, and
the solid-state switch comprises at least one of a transient voltage suppression (TVS) thyristor, a TVS diode, and an integrated gate-commutated thyristor (IGCT).

19. A pre-charge circuit for a direct current (DC) bus of a voltage converter, the pre-charge circuit comprising:
a first resistor and a second resistor coupled in series between a first terminal and a second terminal of the DC bus, with a common node electrically coupled between the first resistor and the second resistor, wherein a voltage between the first terminal and the second terminal comprises a DC bus voltage;
at least one varistor coupled in parallel between the first terminal and the common node;
at least one solid-state switch coupled in series between the common node and the second terminal; and
a capacitor and a third resistor coupled in series between the first terminal and the at least one solid-state switch, wherein the capacitor and the third resistor are configured to receive a current from the DC bus in response to the voltage converter charging the DC bus, and wherein the current terminates in response to the DC bus being charged to the DC bus voltage,
wherein the first resistor and the second resistor are configured to divide the DC bus voltage between the at least one varistor and the at least one solid-state switch, and
wherein the at least one solid-state switch is configured to:
couple the common node to the second terminal of the DC bus in response to the capacitor and the third resistor receiving the current; and
uncouple the common node from the second terminal of the DC bus in response to at least one of the current terminating and a current through the at least one solid-state switch falling below a threshold current.

20. The pre-charge circuit of claim 19, wherein:
the capacitor and the third resistor are coupled in series between the first terminal and the common node, and
the at least one solid-state switch comprises at least one of a transient voltage suppression (TVS) thyristor, a TVS diode, and an integrated gate-commutated thyristor (IGCT).
